(19) United States
(12) Patent Application Publication
(10) Pub. No.: US 2006/0234616 A1
(43) Pub. Date: Oct. 19, 2006

(54) Method for generating a cleaning agent foam, and injector and foam generation system for carrying out the method

(75) Inventors: Wolfgang Holzwarth, Rudersberg (DE); Stefan Schilpp, Fellbach (DE); Juergen Weitzdoerfer, Leutenbach (DE)

Correspondence Address: Lipsitz & McAllister, LLC, 755 MAIN STREET, MONROE, CT, 06468, US

(73) Assignee: Alfred Kaercher GmbH & Co. KG, Winnenden (DE)

(21) Appl. No.: 11/372,360

(22) Filed: Mar. 8, 2006

Related U.S. Application Data
(63) Continuation of application No. PCT/EP04/09473, filed on Aug. 25, 2004.

(30) Foreign Application Priority Data
Sep. 8, 2003 (DE) 103 42 000

(51) Int. Cl. A22C 29/02

(52) U.S. Cl. 452/174; 452/1

(57) ABSTRACT

The invention relates to a method for generating a cleaning agent foam, in which a chemical is admixed with a cleaning liquid by means of an injector (22) and in addition air is admixed by means of a foaming nozzle (34). To develop the method in such a manner that an effective cleaning agent foam can be generated with a reduced proportion of chemical, according to the invention it is proposed that the cleaning liquid/chemical mixture is fed to the foaming nozzle (34) under a pressure of at least 30 bar. There are also proposed an injector (22) and a foam generation system (10) for carrying out the method.

The invention relates to a method for generating a cleaning agent foam, in which a chemical is admixed with a cleaning liquid by means of an injector and in addition air is admixed by means of a foaming nozzle.

The invention also relates to an injector and a foam generation system for carrying out the method.

In high-pressure cleaning appliances with a high-pressure pump, the cleaning liquid which is delivered, generally water, often has a chemical admixed with it by means of an injector in order to improve the cleaning action. A method of this kind is known from DE 36 30 555 A1, air being forced into the outlet-side line of the high-pressure pump by means of a compressed-air compressor. Upstream of the air supply, the chemical can be admixed by means of an injector with the cleaning liquid which has been placed under pressure by the high-pressure pump. Forcing in the air by means of the compressed-air compressor limits the outlet pressure of the high-pressure pump, since the exit pressure of the compressor must be greater than the outlet pressure of the pump. Compressed-air compressors as used in the system described in DE 36 30 555 A1 usually have an exit pressure of at most 12 bar.

There are also systems known in which air can be added to the cleaning liquid/chemical mixture by means of a foaming nozzle to generate a cleaning agent foam which is then applied to the surface that is to be cleaned. This allows the duration of action of the cleaning liquid and the chemical on the surface that is to be cleaned to be increased, and consequently provides a further boost to the cleaning action. This is described, for example, in EP 0 925 124 B1.

From laid-open specification DE 197 05 861 A1, there are known a device for admixing additives and a cleaning and/or disinfection method carried out using this device. The device comprises a main line, namely a pressure tube, which can be connected to the water mains. In the main line is disposed an injector having two suction connection pieces, to each of which is connected a feed line, so that additives can be sucked in from storage containers. Downstream of the injector is an entry location for compressed air, and foam can emerge from a nozzle at the end of the main line. The main line is supplied with water under a pressure of 25 bar, i.e. cleaning foam is generated at pressures of at most 25 bar.

A corresponding device for generating a cleaning agent foam is also described in laid-open specification EP 0 204 673 A2, the foam being generated at pressures of from 3 to 4 bar.

From laid-open specification DE 198 14 740 A1, there are known a method and an apparatus for the rapid decontamination of people in civil defense and in the emergency services. In this case, tap water is heated to 40 to 60° C. and fed to a high-pressure pump. Upstream of the high-pressure pump, i.e. still in the low-pressure region, a decontamination solution can be admixed to the heated tap water by means of a metering pump. The liquid mixture which has been placed under pressure by the high-pressure pump is then expanded via a venturi nozzle which is open on the air side, with the result that as air is sucked in a foam is generated.

In Dutch patent publication NL 82074 C, an injector is described which can be used to admix a chemical to a cleaning liquid.

It is an object of the present invention to provide a method of the type described in the introduction, and also an injector and a corresponding foam generation system, in which an effective cleaning agent foam can be generated with a reduced proportion of chemical.

In a method of the generic type, this object is achieved, according to the invention, by the cleaning liquid/chemical mixture being fed to the foaming nozzle under a pressure of at least 30 bar.

It has been found that when air is admixed to the cleaning liquid/chemical mixture which is under a minimum pressure of 30 bar, it is possible to generate a particularly effective foam, while the proportion of chemical in the cleaning liquid/chemical mixture can be kept low. By way of example, it is possible to apply an effective cleaning agent foam to the surface that is to be cleaned with a chemical proportion of less than 6% based on the proportion of cleaning liquid, in particular a chemical proportion of approximately 3%. On account of the pressure of at least 30 bar, it is possible to achieve a high exit velocity at the outlet of the foaming nozzle, which promotes the formation of foam. A high exit velocity also has the advantage that it is possible to achieve a relatively large “trajectory” for the cleaning agent foam, so that even surfaces which are difficult to reach can be reliably cleaned.

It has proven particularly advantageous if the cleaning liquid/chemical mixture is fed to the foaming nozzle under a pressure of approximately 60 bar to approximately 80 bar. In particular a pressure of the cleaning liquid/chemical mixture of approximately 70 bar to about 80 bar has proven especially favorable to the generation of a particularly effective cleaning agent foam with a low proportion of chemical.

In a preferred embodiment of the method, in a first step the chemical is admixed with the cleaning liquid, the cleaning liquid being fed to the injector under an operating pressure of more than approximately 30 bar, and in a second step air is added to the cleaning liquid/chemical mixture by means of the foaming nozzle. It is in this case advantageous if the operating pressure of the cleaning liquid is approximately 60 bar to about 80 bar, in particular approx. 70 bar to at most about 80 bar. The admixing of a chemical and of air in two successive steps, with the operating pressure of the cleaning liquid being more than approximately 30 bar, has the advantage that the injector may be disposed at the outlet of a high-pressure pump, while the foaming nozzle which is used to admix air can be kept spatially separate from the injector and can be in flow connection with the injector by a single high-pressure line, preferably via a high-pressure hose.

As mentioned in the introduction, the invention also relates to an injector for carrying out the method described above. The injector has an inlet, which can be connected to the pressure port of a high-pressure pump, and an outlet, which can be connected to a pressure line, the inlet being connected to the outlet via a cleaning agent line and a chemical line opening out into the cleaning agent line, and it being possible for a chemical to be sucked in via the chemical line and admixed with the cleaning liquid. To achieve the abovementioned object, according to the invention the injector is configured in such a manner that the chemical can be sucked in and admixed with the cleaning liquid at a cleaning liquid pressure of at least 30 bar. A configuration of this nature has the advantage that the injector can be connected to the high-pressure port of a high-pressure pump which puts the cleaning liquid under a pressure of at least 30 bar. At a cleaning liquid pressure of this level, it is then possible for a chemical, which can be sucked in for example from a storage tank, to be admixed by means of the injector. There is no need for an additional delivery pump for the chemical, and the admixing of the chemical at a cleaning liquid pressure of at least 30 bar ensures that the cleaning liquid/chemical mixture can be fed under high pressure to the pressure line which can be connected to the injector.

It is advantageous if the chemical can be sucked in and admixed with the cleaning liquid at a cleaning liquid pressure of approximately 60 bar to about 80 bar, in particular at a pressure of approximately 70 bar to at most around 80 bar.

It is particularly advantageous if practically no chemical can be admixed with the cleaning liquid if the cleaning liquid pressure exceeds a maximum value. This has the advantage that cleaning liquid which is fed to the injector at a pressure which exceeds the maximum value flows through the injector with scarcely any chemical being admixed, so that the surface that is to be cleaned can be acted on by cleaning liquid which is under high pressure without chemical additionally being applied to the surface.

It is possible to provide for the injector to be configured in such a manner that practically no further chemical can be admixed with the cleaning liquid at a pressure of more than 80 bar.

In a particularly preferred embodiment of the injector according to the invention, the cleaning liquid line forms a cylindrical delivery passage upstream of the nozzle region of the chemical line and a cylindrical combining passage downstream of the nozzle region, the diameter of the combining passage being approximately 1.2 times to 1.4 times the diameter of the delivery passage. It has been found that with a ratio of this kind between the diameters of delivery and combining passages, it is possible to achieve particularly effective admixing of chemical provided that the cleaning liquid pressure does not exceed a predetermined maximum value, whereas if this value is exceeded practically no further chemical is admixed in the injector.

It is preferable for the diameter of the combining passage to be approximately 1.25 times the diameter of the delivery passage.

It is advantageous if the combining passage is approximately 6 times as long as the delivery passage.

It is particularly expedient if the delivery passage widens conically in the direction of the nozzle region, with a cone angle of approximately 90°.

It may be provided that the cleaning liquid line upstream of the delivery passage forms a feed line passage which narrows continuously in the direction of flow and comprises an entry portion which narrows in the shape of an arc as seen in longitudinal section. The entry portion which narrows in the shape of an arc reduces the risk of turbulence forming upstream of the nozzle region, which could impair the admixing of the chemical.

It has proven particularly advantageous if the entry portion merges continuously into a line portion which narrows conically in the direction of flow and is adjoined by the delivery passage, the cone angle of the line portion being approximately 30°.

Further optimization of the flow conditions within the injector according to the invention can be achieved if the cleaning liquid line forms a cylindrical connection passage upstream of the feed line passage. The connection passage makes it easier to connect the injector to a pressure port of a high-pressure pump, while at the same time disruptions to the flow conditions within the injector can be kept very low.

To optionally allow generation of cleaning agent foam or the discharging of cleaning liquid without admixed chemical, it is advantageous if the inlet to the injector is connected to the outlet of the injector via a bypass line, a bypass valve being connected into the bypass line, and it being possible for the bypass line to be opened up by means of the bypass valve if the pressure of the cleaning liquid exceeds a predetermined maximum value. This has the advantage that as a function of the pressure of the cleaning liquid at the inlet to the injector, either a chemical can be admixed with the cleaning liquid in the region of the cleaning liquid line or the cleaning liquid can bypass the cleaning liquid line of the injector and be fed via the bypass line to the outlet of the injector, without the user having to actuate a control element for this purpose.

It is expedient if the bypass line can be opened up at a cleaning liquid pressure of approximately 80 bar.

The invention also relates to a foam generation system for carrying out the method described in the introduction. The foam generation system according to the invention comprises a high-pressure pump which delivers cleaning liquid, an injector of the type described above for admixing a chemical to the cleaning liquid and a foaming nozzle for admixing air to the cleaning liquid/chemical mixture. The foam generation system is distinguished by the fact that the injector is disposed at the high-pressure pump and is in flow connection with the foaming nozzle via a pressure line, it being possible for the cleaning liquid/chemical mixture to be fed to the foaming nozzle under a pressure of at least approximately 30 bar via the pressure line.

As has already been explained, it is possible to generate a particularly effective cleaning agent foam with a low proportion of chemical by admixing air to the cleaning liquid/chemical mixture which is under a pressure of at least 30 bar. The foam generation system can in this case be handled in a particularly simple way, because disposing the injector at the high-pressure pump and connecting the injector to the foaming nozzle via a pressure line allows a compact configuration of the foam generation system, making it very simple to use.

As has already been explained, it is expedient if the cleaning liquid/chemical mixture can be fed to the foaming nozzle under a pressure of approximately 60 bar to about 80 bar. A pressure of approximately 70 bar to around 80 bar has proven particularly advantageous.

In a preferred embodiment of the foam generation system according to the invention, the foaming nozzle is mounted on a nozzle button, for example a cleaning gun, which comprises a high-pressure nozzle, it being possible optionally for the foaming nozzle to be supplied with the cleaning liquid/chemical mixture or for the high-pressure nozzle to be supplied with cleaning liquid. A configuration of this nature has the advantage that the user can optionally supply a surface that is to be cleaned with cleaning liquid which is under high pressure by means of the high-pressure nozzle or with cleaning agent foam by means of the foaming nozzle. It is in this case expedient if the high-pressure nozzle can be supplied with cleaning liquid which is under a pressure of at least 100 bar, preferably at approximately 120 to approximately 250 bar, whereas the foaming nozzle can be supplied with cleaning liquid/chemical mixture which is under a pressure of at least 30 bar, preferably at approximately 60 to about 80 bar. This enables the user to apply cleaning liquid which is under very high pressure to the surface that is to be cleaned and also enables the cleaning agent foam to be applied under high pressure, with a somewhat lower pressure being used for the cleaning agent foam than for the cleaning liquid.

The following description of a preferred embodiment of the invention, in conjunction with the drawing, serves to provide a more detailed explanation. In the drawing:

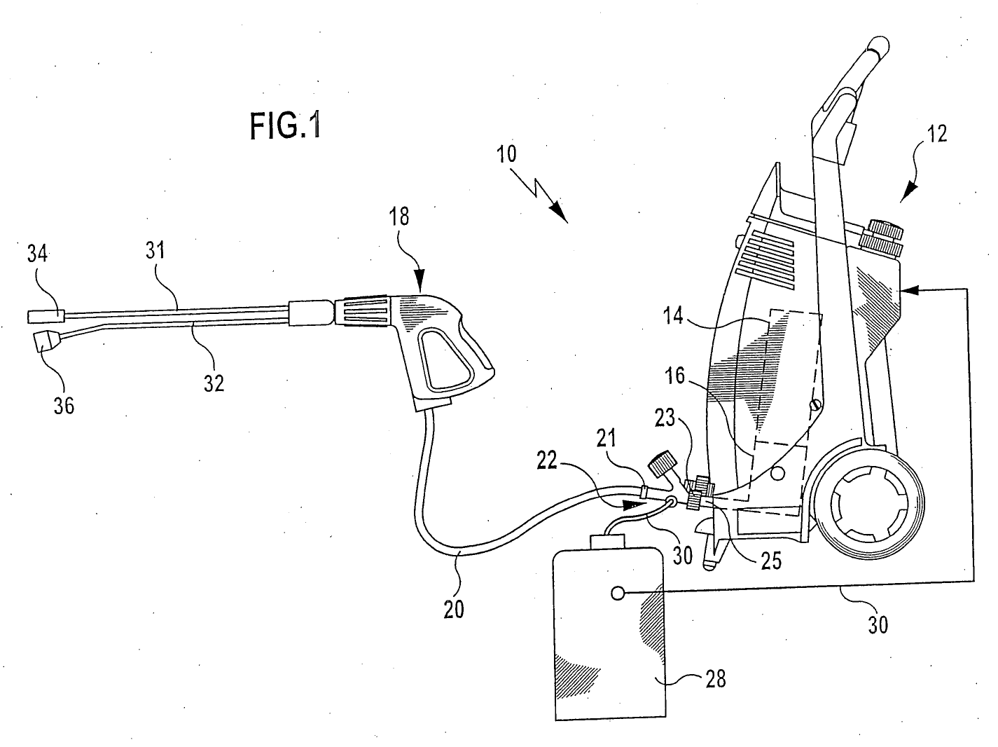

FIG. 1: diagrammatically depicts a foam generation system according to the invention, and

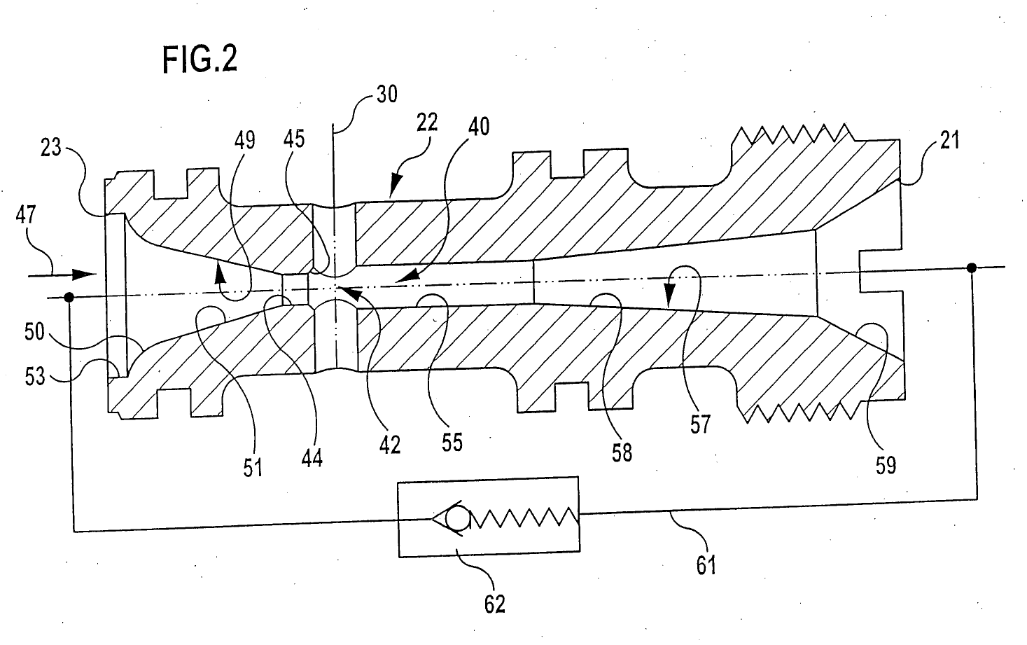

FIG. 2: diagrammatically depicts an injector according to the invention which is used in the foam generation system according to FIG. 1.

In the drawing, there is illustrated a foam generation system, which is denoted overall by reference sign 10, having a high-pressure cleaning appliance 12, which comprises a high-pressure pump 16 driven by an electric motor 14, and having a nozzle button in the form of a cleaning gun 18, which is connected via a high-pressure line in the form of a high-pressure hose 20 to the outlet 21 of an injector 22, the inlet 23 of which is connected to the pressure port 25 of the high-pressure pump 16. The foam generation system 10 also has a chemical container 28 which is in flow connection with the injector 22 via a chemical line 30. The chemical container 28 may be configured as a separate structural unit, as illustrated in FIG. 1. Alternatively, it may be provided that the chemical container 28 is integrated into the high-pressure cleaning appliance 12. This is illustrated by the arrow 30 in FIG. 1.

The cleaning gun 18 has a pistol-like handle as well as a first and a second outlet line 31, 32, which can be supplied with liquid as desired. A foaming nozzle 34 is held at the free end of the first outlet line 31, while the free end of the second outlet line 32 carries a high-pressure nozzle 36. The cleaning gun 18 is, in a manner known per se, configured in such a way that as desired either cleaning agent foam can be applied to a surface that is to be cleaned via the foaming nozzle 34 or cleaning liquid without additional chemical can be applied to the surface that is to be cleaned via the high-pressure nozzle 36. With the aid of the foaming nozzle, air can be added to the cleaning liquid/chemical mixture supplied. Foaming nozzles of this type are known to the man skilled in the art, as are the high-pressure nozzle 36 and cleaning gun 18.

Cleaning liquid, preferably water, can be delivered by means of the high-pressure pump 16, it being possible for the cleaning liquid to be fed at high pressure to the injector 22 and then, via the high-pressure hose 20, to the cleaning gun 18. In the region of the injector 22, a chemical can be admixed with the cleaning liquid that has been delivered, so that pressurized cleaning liquid/chemical mixture can be fed to the foaming nozzle 34 via the high-pressure hose 20.

The injector 22 which is used to admix the chemical is illustrated in more detail in FIG. 2. It comprises a cleaning agent line 40, which passes through the injector 22 in the longitudinal direction, connects the inlet 23 of the injector to the outlet 21 and into which the chemical line 30 opens out at right angles in a nozzle region 42. Upstream of the nozzle region 43, the cleaning agent line 40 forms a cylindrical delivery passage 44, which opens out via a conical end portion 45 into the nozzle region 43 and upstream of which there extends a feed line passage 49 which narrows continuously in the direction of flow 47. The feed line passage 49 has an entry portion 50 which narrows in the shape of arc as seen in longitudinal section and is adjoined in the direction of flow 47, without any sudden changes in cross section, by a conical line portion 51. The line portion 51 has a cone angle of approximately 30°.

A cylindrical connection passage 53, via which the inlet 23 of the injector is in flow connection with the feed line passage 49, extends upstream of the feed line passage 49.

Downstream of the nozzle region 43, the cleaning agent line 40 forms a cylindrical combining passage 55, which in the direction of flow 47 is approximately six times as long as the delivery passage 44 and the diameter of which is approximately 1.25 times the diameter of the delivery passage 44. The combining passage 45 is adjoined, in the direction of flow 47, by an outlet passage 57 having a first outlet portion 58, which conically widens with a cone angle of approximately 10° in the direction of flow 47, and having a second outlet portion 59, which conically widens with a cone angle of approximately 60° as far as the outlet 21 of the injector 22.

A bypass line 61, which connects the inlet 23 to the outlet 21 of the injector 22 and into which a spring-loaded bypass valve 62 is connected, runs parallel to the cleaning agent line 40. The bypass valve 62 is configured in such a manner that it opens when a cleaning liquid pressure of more than 80 bar prevails in the region of the inlet 23, so that at cleaning liquid pressures of more than 80 bar the injector 22 can be bypassed, whereas at a pressure of less than 80 bar the bypass line 62 is closed and as a result all of the cleaning liquid delivered by the high-pressure pump 16 flows through the injector 22. The flow of the cleaning liquid through the injector 22 causes chemical to be sucked in from the chemical container 28 and to be admixed with the cleaning liquid via the chemical line 30. The size ratios explained above, in particular for the delivery passage 44 and the combining passage 25, as well as the geometry of the feed line passage 49, of the upstream connection passage 53 and of the outlet passage 57, are selected in such a manner that chemical is sucked in in an effective manner at pressures below 80 bar, whereas at cleaning liquid pressures of more than 80 bar practically no further chemical is sucked in from the chemical container 28.

To apply a cleaning agent foam to a surface that is to be cleaned, the cleaning agent/chemical mixture can be fed to the foaming nozzle 34, so that air can additionally be admixed to the mixture supplied. The flow diameter of the foaming nozzle is in this case selected in such a manner that when the high-pressure pump 16 is active, a cleaning liquid pressure of approximately 70 to at most 80 bar is set at the pressure connection 25, so that chemical is sucked in from the chemical container 28 and the cleaning liquid/chemical mixture generated in this way is fed to the foaming nozzle 33 via the high-pressure hose 20 and the first outlet line 31. Air can be admixed in the usual way by means of the foaming nozzle 34, and the pressurized cleaning liquid/chemical mixture can then be applied to the surface that is to be cleaned at a high exit velocity in the form of a cleaning agent foam.

Alternatively, the user can activate the high-pressure nozzle 36, the flow diameter of which is smaller than the flow diameter of the foaming nozzle. This has the result that a cleaning liquid pressure of at least 120 bar to at most 250 bar is set in the region of the pressure port 25. This in turn causes the bypass valve 62 to adopt its open state, and thus cleaning liquid delivered by the high-pressure pump 16 can bypass the injector 22. Cleaning liquid which nevertheless flows through the injector 22 under high pressure, on account of the flow ratios which are set under these conditions, produces only a very low suction action for the chemical, so that virtually no chemical is admixed with the cleaning liquid. The cleaning liquid, which is under very high pressure, can be fed to the high-pressure nozzle 36 via the high-pressure hose 20 and the second outlet line 32 and can be applied by this high-pressure nozzle 36 to the surface that is to be cleaned. The high-pressure nozzle 36 is held such that it can be releasably connected to the second outlet line 32 by means of connecting means which are known per se and consequently are not illustrated in the drawing. This gives the user the possibility of using different high-pressure nozzles, which differ in particular with regard to their nozzle diameter. The larger the diameter of the high-pressure nozzle selected, the lower the cleaning liquid pressure which is set in the region of the pressure port 25. Therefore, the operating pressure of the cleaning liquid can be varied by selecting a suitable high-pressure nozzle 36.

1. Method for generating a cleaning agent foam, in which a chemical is admixed with a cleaning liquid by means of an injector and air is admixed by means of a foaming nozzle, wherein the cleaning liquid/chemical mixture is fed to the foaming nozzle under a pressure of at least 30 bar.

2. Method according to claim 1, wherein the cleaning liquid/chemical mixture is fed to the foaming nozzle under a pressure of at least 60 bar to 80 bar.

3. Method according to claim 1, wherein in a first step the chemical is admixed with the cleaning liquid, the cleaning liquid being fed to the injector under an operating pressure of more than 30 bar, and e in a second step air is added to the cleaning liquid/chemical mixture by means of the foaming nozzle.

4. Method according to claim 3, wherein the operating pressure is 60 bar to 80 bar.

5. Injector for carrying out the method of claim 1, comprising:
an inlet, which can be connected to the pressure port of a high-pressure pump,
an outlet, which can be connected to a pressure line,
the inlet being connected to the outlet via a cleaning agent line and a chemical line opening out into the cleaning agent line such that a chemical can be sucked in via the chemical line and admixed with the cleaning liquid at a cleaning liquid pressure of at least 30 bar.

6. Injector according to claim 5, wherein the chemical can be sucked in and admixed with the cleaning liquid at a cleaning liquid pressure of from 70 bar to at most 80 bar.

7. Injector according to claim 5, wherein no chemical can be admixed with the cleaning liquid if the pressure of the cleaning liquid exceeds a maximum value.

8. Injector according to claim 7, wherein no further chemical can be admixed with the cleaning liquid at a cleaning liquid pressure of more than 80 bar.

9. Injector according to claim 5, wherein the chemical line opens out into the cleaning liquid line in a nozzle region, the cleaning liquid line forming a cylindrical delivery passage upstream of the nozzle region and a cylindrical combining passage downstream of the nozzle region, and the diameter of the combining passage being 1.2 times to 1.4 times the diameter of the delivery passage.

10. Injector according to claim 9, wherein the combining passage is six times as long as the delivery passage.

11. Injector according to claim 9, wherein the delivery passage widens conically in the direction of the nozzle region with a cone angle of 90°.

12. Injector according to claim 9, wherein the cleaning liquid line upstream of the delivery passage forms a feed line passage which narrows continuously in the direction of flow and comprises an entry portion which narrows in the shape of an arc as seen in longitudinal section.

13. Injector according to claim 12, wherein the entry portion merges continuously into a line portion which narrows conically in the direction of flow and is adjoined by the delivery passage, the line portion having a cone angle of 30°.

14. Injector according to claim 12, wherein the cleaning liquid line forms a cylindrical connection passage upstream of the feed line passage.

15. Injector according to claim 5, wherein:
the inlet is connected to the outlet via a bypass line,
a bypass valve being is connected into the bypass line, and
the bypass line is openable by means of the bypass valve if the pressure of the cleaning liquid exceeds a predetermined maximum value.

16. Injector according to claim 15, wherein the maximum value is 80 bar.

17. Foam generation system comprising:
a high-pressure pump which delivers cleaning liquid,
an injector according to claim 5 for admixing a chemical to the cleaning liquid, and
a foaming nozzle for admixing air to the cleaning liquid/chemical mixture,
wherein the injector is disposed at the high-pressure pump and is in flow connection with the foaming nozzle via a pressure line, the cleaning liquid/chemical mixture being feedable to the foaming nozzle under a pressure of at least 30 bar via the pressure line.

18. Foam generation system according to claim 17, wherein the cleaning liquid/chemical mixture can be fed to the foaming nozzle under a pressure of from 60 bar to 80 bar.

19. Foam generation system according to claim 17, wherein the foaming nozzle is mounted on a nozzle head which comprises a high-pressure nozzle, it being possible optionally for the foaming nozzle to be supplied with the cleaning liquid/chemical mixture or for the high-pressure nozzle to be supplied with cleaning liquid.

20. Injector according to claim 5, wherein the chemical can be sucked in and admixed with the cleaning liquid at a cleaning liquid pressure of from 60 bar to 80 bar.
